(19) United States
(12) Patent Application Publication
(10) Pub. No.: US 2025/0068147 A1
(43) Pub. Date: Feb. 27, 2025

(54) ADAPTIVE FAULT PREDICTION

(71) Applicant: The Regents of the University of Michigan, Ann Arbor, MI (US)

(72) Inventors: Maxwell F. TOOTHMAN, Ann Arbor, MI (US); James R. MOYNE, Canton, MI (US); Dawn M. TILBURY, Ann Arbor, MI (US); Kira BARTON, Ann Arbor, MI (US)

(21) Appl. No.: 18/816,651

(22) Filed: Aug. 27, 2024

Related U.S. Application Data
(60) Provisional application No. 63/534,844, filed on Aug. 27, 2023.
(60) Provisional application No. 63/572,030, filed on Mar. 29, 2024.

(51) Int. Cl. G05B 19/418

(52) U.S. Cl. CPC G05B 19/4184

(57) ABSTRACT

A state-based framework is the basis for a methodology for predicting faults in industrial equipment or processes during multi-stage degradation. The methodology is based on an object-oriented scheme that allows system experts to identify signal trajectory classes that may occur during degradation. The methodology uses recent observations of a signal feature to estimate the current health stage of a system and extrapolates signal trajectories forward in time to obtain probabilistic fault time estimates. The framework's ability to incorporate subject matter expertise reduces the need for extensive historical training data and includes an anomaly detection sub-process to identify signal trends that deviate from expected behavior.

### TECHNICAL FIELD

This disclosure is related to fault prediction and, in particular, to fault prediction in mechanical equipment and other industrial systems.

### BACKGROUND

Under condition-based and predictive maintenance strategies for industrial equipment, maintenance and repair procedures may be carried out based on estimates of current and future equipment health. Incorporating health estimates into a factory's maintenance strategy can help avoid catastrophic machine failure and unnecessary preventative maintenance procedures, resulting in sizeable production and cost benefits. Manufacturers employing a predictive maintenance strategy experience fewer defects and less downtime compared to manufacturers employing a preventative maintenance strategy.

Manufacturers have become increasingly interested in predictive modeling of industrial systems such as rotating equipment, but predictive capabilities are difficult to attain in industrial applications. Traditional predictive modeling relies on large model training datasets, which are not normally available for industrial equipment. Additionally, degradation in such equipment usually takes place over extended periods of time with shifting dynamics that change the trajectory of machine signals. This presents difficulties for methods that rely on “snapshot” analyses to make predictions based only on the magnitudes of recent machine signal measurements and/or make strict assumptions about the trajectory of machine signals during degradation.

Several data-driven methods have been proposed for fault prediction, but most of these make predictions based solely on snapshots of machine signal magnitudes. Such models tend to have limited lifespans in industry, where maintenance procedures and operating variations commonly affect the machine signal baselines that characterize healthy operation. Some trend-based models have also been proposed, including long short-term memory networks. An approach known as general path modeling (GPM) has also been proposed. But these models have been based on overly restrictive assumptions about degradation trajectories and the number of stages included in machine degradation. Additionally, much of this work has relied on Bayesian updating, which requires prior distributions for all random model parameters. Historical data from stretches of time that result in a fault are necessary to derive these distributions but are often unavailable for the industrial system of interest.

### SUMMARY

Embodiments of a method for predicting a system fault in a monitored system are based on a predefined global automaton that includes a plurality of distinct degradation stages, a transition from a healthy stage to at least one of the degradation stages, and a transition from at least one of the degradation stages to a faulty stage. Each of the plurality of degradation stages corresponds to a different signal feature trajectory class.

Embodiments of the method may include one or more of the following features combined in any technically feasible combination:
each trajectory class is defined at least in part by a monitorable signal feature of the system and a state equation that is a function of the signal feature, the state equation being different for each of the feature trajectory classes;
each trajectory class is defined at least in part by a monitorable signal feature of the system and a state equation that is a function of the signal feature and a variable parameter, the variable parameter being different for each of the feature trajectory classes;
each trajectory class is defined at least in part by a monitorable signal feature, a state equation that is a function of the signal feature and a parameter, and a constraint on the parameter;
each trajectory class corresponding to one of the degradation stages having a transition to the faulty stage is a trending trajectory class;
the global automaton includes a plurality of degradation paths from the healthy stage to the faulty stage;
at least one degradation path of the global automaton includes more than one of the plurality of degradation stages;
an iterative fault prediction step based on extrapolation of a signal feature trajectory of one of the degradations stages having a transition to the faulty stage;
an iterative fault prediction step based on a signal feature history and health stage history of the monitored system and independent from external degradation models;
one of the plurality of degradation stages is an unknown degradation stage used to capture signal feature behavior that does not fit within any of the other degradation stages;
repeated system monitoring, including: observing a new instance of a signal feature upon which each trajectory class is based; and making a determination pertinent to a current health stage of the monitored system using the observed new instance of the signal feature. The current health stage is selected from the healthy stage or one of the degradation stages of the global automaton;
using a stage estimation process that determines an estimated probability that the monitored system has transitioned from the current health stage to a next health stage of the global automaton based in part on the observed new instance of the signal feature;
using a trajectory updating process that determines a value for a variable parameter of a state equation of the trajectory class corresponding to the current health stage based in part on the observed new instance of the signal feature;
using a fault prediction process that determines a predicted time to reach the system fault by extrapolating a trajectory of the signal feature based on previously observed instances of the signal feature, including the observed new instance of the signal feature;
using an anomaly detection process that determines whether the observed new instance of the signal feature is anomalous relative to previously observed instances of the signal feature;
a step of defining a local automaton indicative of a health stage history of the monitored system, the local automaton including a current health stage of the monitored system selected from the healthy stage or one of the degradation stages, wherein the health stage history includes only health stages that are part of the global automaton;
a step of expanding the local automaton to include an additional degradation stage of the global automaton;
a step of modifying the global automaton to include a new degradation stage that corresponds to a new signal feature trajectory class;
the new signal feature class is based at least in part on one or more anomalous signal feature observations; and/or
the monitored system is an industrial process.

### BRIEF DESCRIPTION OF DRAWINGS

FIG. 1 depicts a template for a feature trajectory class;

FIG. 2 depicts an example of a feature trajectory class based on the template of FIG. 1;

FIG. 3 depicts an example of a global automaton;

FIG. 4 depicts an example of a local automaton derived from the global automaton of FIG. 3;

FIG. 5 depicts an example of an adaptive methodology for estimating the health stage history of a system and providing a prediction of system faults;

FIG. 6 depicts a global automaton based on the disclosed framework and methodology and used to predict bearing faults in an experimental example;

FIG. 7 depicts trajectory classes corresponding to the global automaton of FIG. 6;

FIG. 8 illustrates stage estimation and fault prediction results during one degradation episode of the experimental example associated with FIGS. 6 and 7;

FIG. 9 depicts an example of the adaptive methodology of FIG. 5 further including expansion of the global automaton;

FIG. 10 depicts an example of a global automaton for use in fault prediction for an industrial filament-based lamp;

FIG. 11 depicts an example of a local automaton based on the global automaton of FIG. 10;

FIG. 12 depicts an example of expansion of the local automaton of FIG. 11 based on the global automaton of FIG. 10;

FIG. 13 depicts an updated global automaton based on the global automaton 20 of FIG. 10 after a trend in a monitored signal feature is detected; and

FIG. 14 depicts an example of expansion of the local automaton of FIG. 12 based on the updated global automaton of FIG. 13.

### DESCRIPTION OF EMBODIMENTS

Described below is a state-based framework for modeling industrial equipment health based on multi-stage degradation models. The methodology can predict faults in industrial systems such as mechanical and/or electrical systems during multi-stage degradation and is based on an object-oriented scheme that allows system experts to identify signal trajectories that may occur during degradation. The fault prediction process uses recent sensor measurements to estimate the health stage of the monitored system and extrapolates signal trajectories forward in time to obtain probabilistic fault time estimates and quantification of confidences in these estimates. The framework's ability to incorporate subject matter expertise reduces the need for extensive historical training data. The framework may also include an anomaly detection subprocess to identify signal trends that deviate from expected behavior and/or identify novel signal trajectories not predicted prior to a degradation episode. This framework makes fault prediction more attainable in industry by allowing subject matter experts to specify expected degradation behavior without the need for historical data. The fault prediction methodology is adaptive and uses this framework to estimate the most likely health stage history of the system and make fault predictions accordingly.

The methodology is particularly applicable to industrial systems in manufacturing facilities, power plants, chemical treatment plants, refineries, etc. “Industrial systems” include mechanical systems with moving and/or wearable components, along with non-mechanical systems having components with a finite service life and processes that can be evaluated by metrics of performance. A “mechanical system” is any mechanical or partly mechanical system with moving parts, including entire machines, machine subsystems, and/or machine components. Mechanical systems may include electrical or electronic components. The methods disclosed below are also applicable to all-electrical systems without moving parts, such as power transformers, infrared heating systems, thermoelectric devices, etc. “Industrial systems” include processes, such as those in semiconductor or pharmaceutical manufacturing that produce products or components of products with varying quality.

A “subject matter expert” (SME) is a human with knowledge and/or experience related to the mechanical system for which a fault prediction model is desired. Machine operators and machine maintenance engineers are examples of SMEs. A “user” of the framework, methodology, related methods, and/or systems carrying out those methods may be an SME or a person using the knowledge of an SME to construct a predictive model.

An industrial system “event” that can be predicted by a model may be a catastrophic failure or a system fault. A “catastrophic failure” is characterized by a complete halt in operation of the mechanical system. Catastrophic failure events can be extremely costly but are relatively rare due to a combination of systems being designed to reduce the risk of failure events as much as possible and preventative maintenance strategies typically employed in an industrial setting.

A “system fault” event is an anomaly associated with an unwanted situation in the industrial system that requires immediate system maintenance or repair to resolve. System fault events occur more frequently than catastrophic failures in industrial systems such as rotating equipment. A system fault may be characterized by the violation of a quantitative fault threshold that defines acceptable system operation. For example, limits-based monitoring of a critical system signal may be used to identify a system fault and to trigger a maintenance alarm when the fault is identified. An example of a quantitative fault threshold for an industrial pump is a minimum flowrate threshold that must be maintained. If the pump flowrate falls below the threshold flowrate, a system fault is identified, and a maintenance alarm may be triggered. Another example of a quantitative fault threshold for an industrial pump is a maximum leak rate of a process fluid. If the process fluid leak rate exceeds the threshold leak rate, a system fault is identified, and a maintenance alarm may be triggered.

Fault monitoring in these situations may be accomplished by univariate analysis (UVA) in which signals are independently monitored and evaluated. In applications where system health problems are not associated with a single critical system signal, a number of multivariate analysis (MVA) techniques can be used to transform multiple signals into a low-dimensional system health index that can be the basis for a fault threshold.

As used herein, “fault prediction” involves detecting or otherwise obtaining information pertinent to system degradation as the system approaches a quantitative fault threshold and making predictions about when system faults will occur. These predictions might include a “time to failure” (TTF) or “remaining useful life” (RUL) indication as well as some quantification of prediction quality, such as probability of impending failure or upper or lower confidence limits on TTF or RUL. When the physics of a degradation process is well-understood and can be directly monitored, fault predictions can be made based on first-principle models. Unfortunately, this is not the case for most industrial machines, which tend to experience unique failure modes and do not typically include extensive sensing suites providing data pertinent to impending faults. While data-driven tools can be useful for detecting and forecasting degradation in some applications, the various machine learning methods, trend-based models, deep-learning models, and general path models that have been proposed for fault prediction in mechanical or other industrial systems are plagued by the problems noted above.

### Modeling Architecture

The expected behavior of signal features (x) over time can be modeled with state-based feature trajectories. A “feature trajectory” can be defined as a discrete-time state equation that describes a feature value, or “state,” at the next time step (xₜ₊₁) as a function of the feature value at the current time step (xₜ) and a set of trajectory parameters (p), as expressed in Equation 1:

$${x}_{t + 1} = f ( {x}_{t} , p ) . \qquad ( 1 )$$

Individual feature trajectories are instantiations of feature trajectory classes that have been specified by machine experts prior to online monitoring. Each “trajectory class” defines a signal feature that the feature trajectory describes and the structure of the state equation (f). Each “trajectory parameter” (p) is designated as either fixed or variable. Fixed parameters have a constant value throughout a degradation episode, while variable parameters are continually updated based on recent feature observations. A “degradation episode” is a stretch of time leading up to a system fault. Feature trajectory classes should include a method to instantiate trajectories by estimating the value of all parameters based on a set of feature observations and a method to update the variable parameters of existing trajectories based on new feature observations. Finally, “parameter constraints” may be defined to specify a range of values that variable parameters can take.

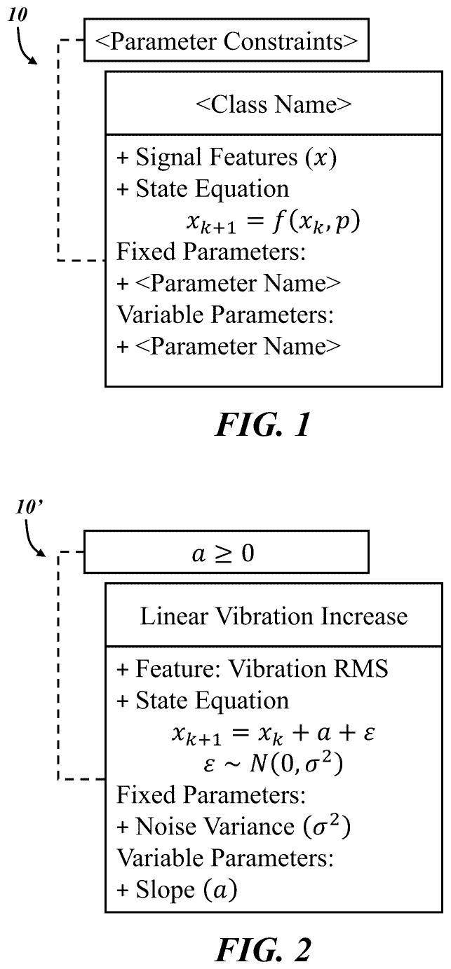

FIG. 1 depicts a template 10 for a feature trajectory class, and FIG. 2 depicts an example of a feature trajectory class 10′ based on the template of FIG. 1. In the example of FIG. 2, the signal feature (x) is the root mean square (RMS) of raw accelerometer vibration measurements, and the trajectory class is a linear increase of that feature. The state equation f(xₜ, p) for this example, x₊₁=xₜ+α+ε, describes a linear increase in x that is impacted by a Gaussian random noise variable, ε˜N(0, σ²). The trajectory parameters for this class can be expressed as p=[α, σ²]. The slope parameter (α) is designated as variable so that it can be updated as new feature observations are made, while the noise variance parameter (σ²) is designated as fixed. A feature trajectory class that predicts feature drift is referred to as a “trending” or “dynamic” feature trajectory class, and a feature trajectory class that does not predict feature drift is referred to as a “non-trending” or “static” feature trajectory class. Non-trending behavior can be used to describe healthy system behavior or offsets in feature values that precede trending degradation behavior. In the example of FIG. 2, a constraint is placed on the variable slope parameter (α) to ensure that the slope of trajectory instances does not fall below zero.

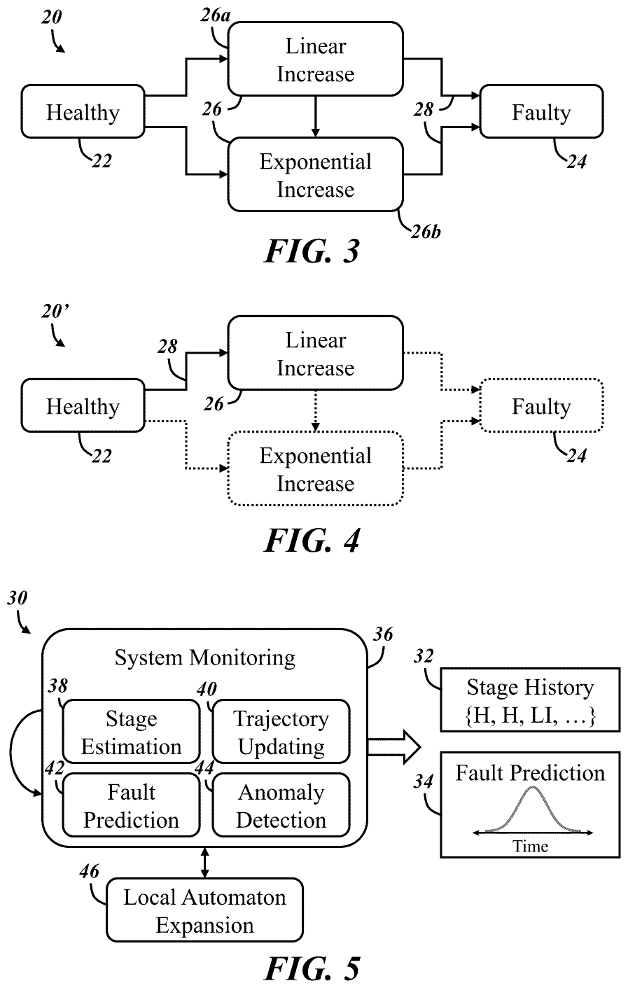

The proposed framework uses global and local system health automata to represent system health stages. An “automaton” is a collection of system health stages and transitions among health stages, where each health stage is defined by a feature trajectory class. FIG. 3 depicts an example of a global automaton 20, and FIG. 4 depicts an example of a local automaton 20′ derived from to the global automaton of FIG. 3. Each automaton 20, 20′ includes a set of stages(S), a set of events (E), and a transition function (g: S×E→S), and the local automaton 20′ is derived from the global automaton 20 as discussed further below.

A global automaton 20 sets forth the possible known degradation paths the monitored system may encounter during operation that lead toward a system fault during a degradation episode. The global automaton 20 for a particular system may be defined by a user (e.g., an SME) and includes a set of health stages including a healthy stage 22, a faulty stage 24, and one or more intermediate health stages 26, which may be classified as degradation stages. The global automaton 20 also includes transitions 28 believed to be possible among the various health stages 22-26. The transitions 28 include at least one transition from the healthy stage 22 to a degradation stage 26 and at least one transition 28 from a degradation stage 26 to the faulty stage 24. To capture anomalous or other behavior that does not align with any pre-defined stage, the global automaton 20 may also include an “unknown” stage. The healthy stage 22 and the degradation stages 26 of a global automaton are associated with a feature trajectory class that describes the general behavior of signal features in that stage. Additionally, each stage 26 with a transition 28 to the faulty stage 24 should be associated with a trending feature trajectory class, which will be used to make fault predictions. The global automaton 20 can be made flexible such that previously unincluded, unknown, or unpredicted failure modes, degradation paths, signal features, and feature trajectories can be added.

The global automaton 20 of FIG. 3 is defined for a system that may experience linear and/or exponential increases in a monitored feature during a degradation episode. The healthy stage 22 acts as the initial stage of system health during online monitoring. According to this global automaton 20, the system is expected to transition from the healthy stage 22 to either a linear increase 26a or an exponential increase 26b in the monitored feature. From the linear increase stage 26a, the system is expected to transition to either the faulty stage 24 or the exponential increase stage 26b. From the exponential increase stage 26b, the system is expected to transition only to the faulty stage 24 without returning to the linear increase stage 26a. The faulty stage 24 has no outgoing transitions to other stages.

A local system health automaton 20′ includes system health stages that describe an ongoing degradation episode based on recent feature observations. The structure of each local automaton 20′ is derived from a corresponding global automaton 20 and adapted in real-time according to the fault prediction methodology described in the following section. The health stages 22-26 and transitions 28 of a particular local automaton 20′ are limited to a subset of those in the corresponding global automaton 20—i.e., the local automaton 20′ cannot include a health stage or transition that is not included in the corresponding global automaton 20. Each degradation stage 26 of a local automaton is associated with a feature trajectory, which is an instance of that stage's associated trajectory class in the global automaton 20. These trajectories have values assigned to all trajectory parameters (p) based at least in part on recent feature observations.

At the beginning of a degradation episode, the local automaton 20′ includes only the healthy stage 22. Additional health stages 26 are added to the local automaton 20′ as degradation trends emerge. The local automaton 20′ of FIG. 4 is derived from the global automaton 20 of FIG. 3 and indicates that the system has transitioned from the healthy stage 22 to the linear increase stage 26a but has not (and may not) experience the exponential increase stage 26b defined in the global automaton. Health stages of the global automaton 20 that have not been experienced by the monitored system, and therefore not part of the local automaton 20′, are depicted in broken lines in FIG. 4 (and subsequent figures depicting local automata). Based on the local automaton 20′ of FIG. 4, at the current health stage 26a of the monitored system, the monitored signal feature is linearly increasing toward the faulty stage 24.

### Fault Prediction Methodology

Described below is an adaptive methodology 30 for estimating the health stage history 32 of a system and providing a prediction 34 of system faults. The methodology 30, depicted by way of example in FIG. 5, involves routine system monitoring 36, which includes four monitoring processes 38-44. The monitoring processes include a stage estimation process 38, a trajectory updating process 40, a fault prediction process 42, and an anomaly detection process 44. Each process 38-44 makes some determination pertinent to the current health stage of the monitored system and is repeated when new feature observations are made—e.g., each time a sensor reading pertinent to a signal feature upon which a trajectory class is based is taken and/or received. Based on the results of the system monitoring 36, an expansion 46 of the local automaton 20′ may be triggered.

An illustrative stage estimation process 38 uses a particle filter to evaluate the health stage histories that may describe an ongoing degradation episode. Here, each particle is composed of a health stage history ([s₁, . . . , sₜ]) and a feature history ([x₁, . . . , xₜ]) up to the current time (t), as well as a normalized weight (w̅):

$$Particle : \{ \begin{matrix}[ {x}_{1} , … , {x}_{t} ] \\ [ {s}_{1} , … , {s}_{t} ]\end{matrix} , \overline{w} \} . \qquad ( 2 )$$

Stage estimation 38 includes a prediction step and an update step, each of which is carried out whenever new feature observations are made, as described below.

The prediction step may be a dynamics-based prediction step for particle filters, such as that described by Doucet, et al. (“On sequential monte carlo sampling methods for bayesian filtering.” Statistics and computing, vol. 10, pp. 197-208, 2000), which can be adapted to enable monitoring of multi-stage degradation. First, the next health stage (sₜ₊₁) of a particle is predicted based on a stage transition probability matrix (T) that corresponds to the system's local automaton. The next state (x₊₁) of each particle is then predicted based on the state equation of health stage sₜ₊₁. The structure of the local automaton 20′ for a given system may change throughout a degradation episode, and the size of the transition matrix must change accordingly. One method for maintaining a valid transition probability matrix is to define a same-stage transition probability for each stage. The probabilities of all outbound transitions in the local automaton can then be assigned equal values such that all rows of the matrix sum to 1. Otherwise, a user can specify a transition probability matrix that corresponds with the associated global automaton 20, and the rows of this matrix can be normalized whenever stages are added or removed from the local automaton.

The update step may include a standard updating method for particle filters (e.g., Doucet, et al.) and may be implemented here to adjust the weight of each particle based on a new feature observation (yₜ₊₁), where (y) denotes an observation of the signal feature (x) at a particular time step. The pre-normalized updated weight (wₜ₊₁) of a particle can be calculated with a dynamics-based prediction equation:

$${w}_{t + 1} = P ( {y}_{t + 1} \vert {x}_{t + 1} ) {\overline{w}}_{t} , \qquad ( 3 )$$

where w̅ₜ is the previous normalized particle weight. A Gaussian observation model can be assumed, so P(yₜ₊₁|xₜ₊₁)=N (yₜ₊₁|xₜ₊₁, Γ). The observation noise parameter (Γ) can be tuned to change the responsiveness of the filter to new observations. When this process has been completed for each particle, normalized particle weights w̅ₜ₊₁ are computed by dividing each w̅ₜ₊₁ by the sum of all pre-normalized particle weights.

After every update, an effective particle size (N_{eff}) can be computed according to:

$${N}_{eff} = \frac{1}{{\sum }_{i = 1}^{N} {( {\overline{w}}^{i} )}^{2}} , \qquad ( 4 )$$

where N is the number of particles. Particles are resampled to combat particle degeneracy when this drops below a critical threshold (N_{crit}).

The trajectory updating process 40 adapts the variable parameters of all active feature trajectories after every new feature observation. An exponentially weighted moving average (EWMA) filter can be implemented to make these updates. When new feature values are observed, the parameter estimation method for each active feature trajectory can be used to compute a new parameter estimate based on the current feature observation (yₜ) and the previous feature observation (yₜ₋₁). For example, the linear trajectory class 10′ depicted in FIG. 2 has a single variable parameter (a), and parameter estimates may be computed by finding the difference between sequential feature observations. The EWMA equation:

$${a}_{t} = β {a}_{c - 1} + ( 1 - β ) {a}^{*} \qquad ( 5 )$$

can then be used to update the value of the variable parameter using the new estimate and the previous parameter value (αₜ₋₁). The rate at which trajectory parameters are updated is dictated by a decay rate variable (β), which may be set to any value in [0, 1]. In cases where the updated parameters of a trajectory violate a class constraint, the particles currently in that stage are transitioned to other health stages according to the local automaton's transition probability matrix.

In an illustrative fault prediction process 42, the proportion of particles that are in a fault-adjacent stage—i.e., a stage with a transition to the Faulty stage in the associated global automaton—dictates whether fault predictions are made at each time step. Users may set a lower proportion threshold to generate fault predictions while the true health stage of the system is still uncertain, or a higher threshold if fault predictions are only necessary later in a degradation episode. When this threshold is met, fault prediction may be implemented by projecting fault-adjacent particles forward in time. As discussed above, this framework assumes that system faults are defined by limits on one or more features. Future particle states ([xₜ₊₁,xₜ₊₂, . . . ]) can be repeatedly calculated using the state update equation of each particle until a fault threshold is met. The fault times of all fault-adjacent particles can be aggregated into an empirical distribution that probabilistically describes the system fault time.

An illustrative anomaly detection process 44 identifies significant disparities between the most recent feature observation (yₜ) and the tracked particles. Anomaly detection considers the probability of observing yₜ given the current particle states: Xₜ=[xₜ¹ . . . xₜ^{N}], where N is the number of tracked particles. A Gaussian observation model may be assumed for each particle such that P(yₜ|xₜ)=N(yₜ|xₜ, Γ). A Gaussian mixture model (GMM) can be used to describe the observation probability distribution with multiple, weighted particles.

The value of P(yₜ|Xₜ) cannot be used for anomaly detection without information about the underlying distribution. The GMM will be multi-modal, so traditional statistical anomaly detection methods like the Z-test cannot be applied. Instead, a high-density region (HDR) is used to describe P(yₜ|Xₜ). A (100−α) % high density region for random variable X with density function ƒ(x) is the subset R(f_{α}) of the sample space of X such that:

$$R ( {f}_{α} ) = \{ x : f ( x ) \geq {f}_{a} \} , \qquad ( 6 )$$

where fa is the largest constant such that Pr(X∈R(f_{α}))≥1−α. The value of f_{α} that defines a (100−α)% HDR can be estimated by generating independent samples from f(x). Because f_{α} is defined such that Pr(X∈R(f_{α}))≥1−α, f_{α} will be the α quantile of these samples.

When new observations are made, Markov chain Monte Carlo sampling may be used to generate samples and estimate f_{α} for the observation probability distribution. If P(yₜ|Xₜ)≥f_{α}, the observation lies within the (100−α)% HDR and is classified as non-anomalous. If P(yₜ|Xₜ)<f_{α}, the observation lies outside the (100−α) % HDR and is classified as anomalous. The value of α can be tuned by users to control the sensitivity of anomaly detection. When α is close to 0, only significant deviations between particles and observations will be considered anomalous. So, larger values may be appropriate when detecting early degradation is critical to the predictive maintenance strategy, even at the risk of false positives.

An illustrative local automaton expansion process 46 adds inactive stages 26 from the global automaton 20 to the local automaton 20′, where the added stage(s) describe the ongoing degradation episode. This process may be triggered by the results of anomaly detection 44, but users can define the exact criteria for expansion 46. For example, local automaton expansion 46 can be triggered by three consecutive anomalies or other statistical process control guidelines.

The expansion process 46 adds one or more health stages 26 and transitions 28 from the global system health automaton 20 to the local system health automaton 20′. Expansion candidates may be identified based on the particle stages prior to the first anomalous feature observation (S_{current}). Using the transition function (g: S×E→S) of the global automaton 20, a set of inactive transitions (Ē_{new}) originating from the stages in S_{current} can be compiled. The stages that these transitions lead to (S̅_{new}) are then identified, and instances of their associated feature trajectory classes are trained using the recent anomalous observations. The set of stages (S_{new}) with trajectories whose variable parameters do not conflict with class constraints are then added to the current local automaton 20′ along with the transitions that lead to those stages (E_{new}). Finally, the routine system monitoring 36 is repeated for the recent anomalous data with the newly expanded local automaton 20′.

As shown in FIG. 5, the outputs of the methodology include probabilistic descriptions of the health stage history 32 of the system and predicted fault time 34. The probability that the system was in stage s* at time t is estimated based on the proportion of particles with a stage history that satisfies sₜ=s*. System fault predictions 34 can be derived from the empirical fault distribution described above using statistics such as an expected value or a confidence interval.

### Case Study

A study was conducted implementing the above-described framework to predict faults in rolling element bearings as an example of a mechanical system. The dataset used for the study was collected and published by the FEMTO-ST Institute and includes vibration data from several tests that are each considered to be a degradation episode. The study considered seven tests conducted with identical bearings and operating parameters.

The study was based on vibration RMS measurements as the monitored feature, which is a feature known to increase as a roller bearing degrades. Noise was filtered from the raw RMS values using an EWMA filter with a 0.95 decay rate. Since the dataset did not specify the criterion used to stop each test, a fault threshold for each test was retroactively calculated by averaging the final five RMS values for purposes of this study. In practice, fault thresholds can be set based on preexisting alarm thresholds or an analysis of historical data before emergency shutdowns.

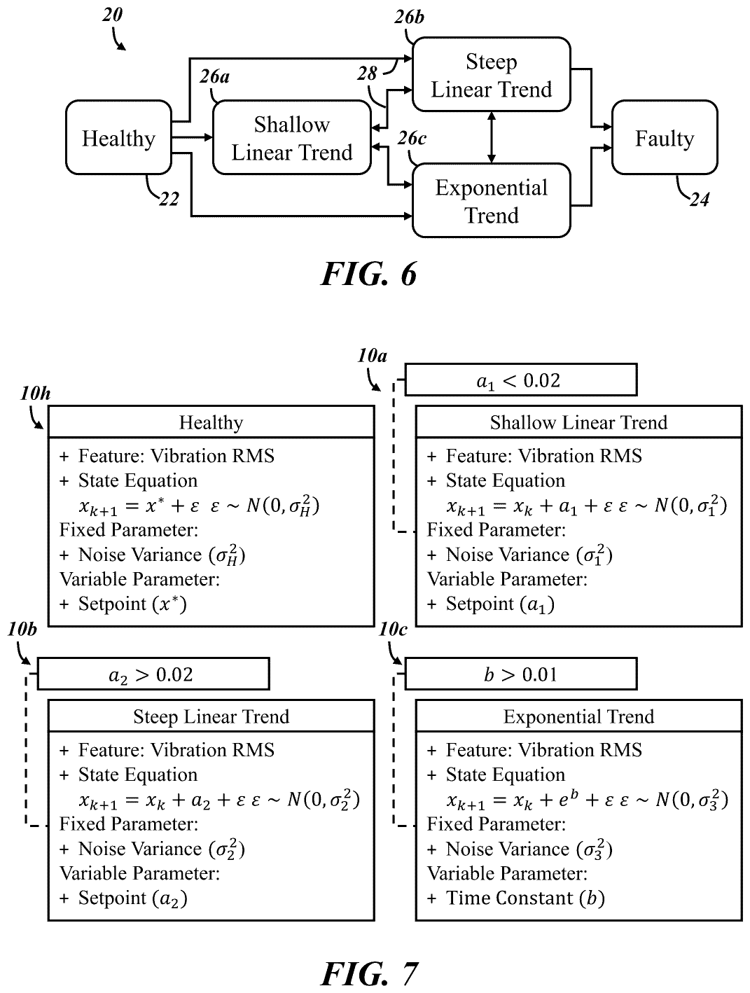

The above-described framework and methodology were used to predict bearing faults in each of the seven degradation episodes with the global automaton 20 illustrated in FIG. 6, and with the corresponding trajectory classes 10h and 10a-10c illustrated in FIG. 7. The trajectory classes 10b, 10c for the associated steep linear trend and exponential trend stages 26b, 26c have lower limits on their variable parameters to ensure that they are only activated when significant RMS increases are observed. A shallow linear trend stage 26a is included to describe slow increases in RMS that often occur early in rolling bearing degradation processes. The trajectory class 10a for this stage 26a has an upper limit on its slope parameter to force a transition to one of the later stages 26b, 26c when RMS starts to increase more rapidly. Notably, there is no transition 28 between the shallow linear trend stage 26a and the faulty stage 24, so fault predictions will not be computed when the stage estimation process 38 indicates that the system is in this stage 26a.

The study focused on the final 30% of the dataset for each test. The mean of RMS observations from the first 70% was used to define the setpoint parameter x* for the healthy stage 22. The noise variance parameters (σ_{H}, σ₁, σ₂, σ₃) are all set to be the variance of the healthy RMS observations, and the variance of the Gaussian observation model (Γ) is defined to be twice this value. During the system monitoring process 36, a critical particle size threshold N_{crit}=300 was set to trigger resampling, and fault predictions were computed when 50% of particles were in a fault-adjacent stage 26b, 26c. Local automaton expansion 46 was triggered when five consecutive RMS observations were classified as anomalous, where anomaly detection was implemented with α=25. During all tests, local automata were defined such that all stages had a 0.9 same-stage transition probability, with the remaining 0.1 probability split equally among all other transitions.

To derive quantitative prediction accuracy metrics, the weighted samples that make up empirical fault prediction distributions were first grouped into 50 bins of uniform width, and the bin with the highest combined weight was selected as a point estimate of the fault time. This process mirrors the maximum a posteriori probability (MAP) estimate that can be used with continuous distributions. A mean absolute percent error (MAPE) value was calculated to summarize the accuracy of all predictions made during a single degradation episode. This metric is described as:

$$MAPE = \frac{{\sum }_{i = 1}^{n} \frac{\vert To {F}_{{pred}^{}} - T o {F}_{a c t} \vert}{{ToF}_{a c t}}}{n} \times 1 \; 00 \% , \qquad ( 6 )$$

where ToF_{pred} is the predicted fault time, ToF_{act} is the actual fault time, n is the total number of fault predictions made throughout the degradation episode.

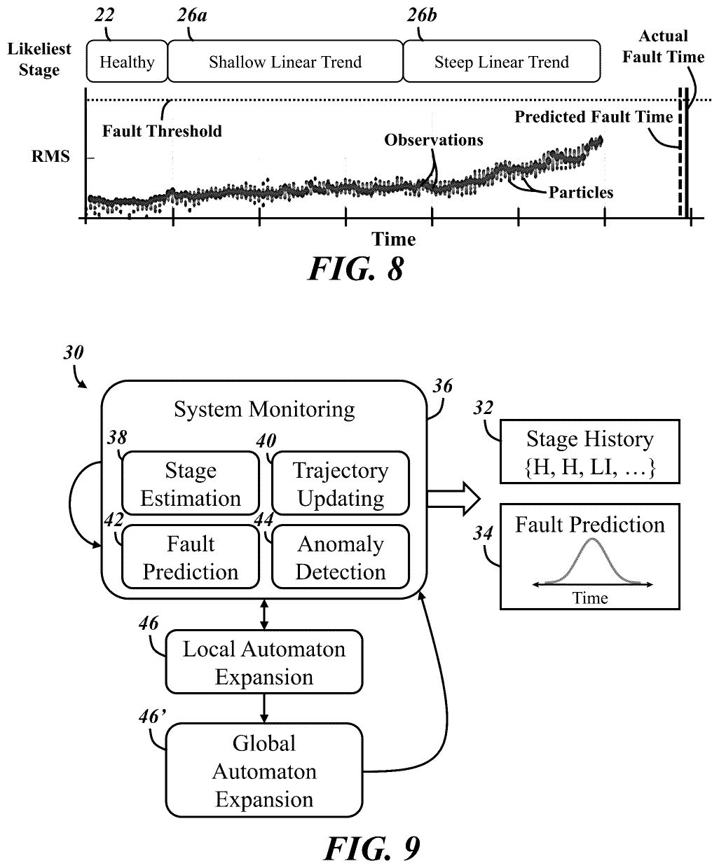

FIG. 8 illustrates the stage estimation and fault prediction results according to the above-described methodology during one degradation episode. In FIG. 8, each time point includes multiple particles and an observation. The observation data points viewed together in FIG. 8 appear as a generally continuous function and are darker than the particles at each time point. The RMS observations begin to increase slightly from their healthy setpoint near the beginning of the illustrated time period, triggering a transition to the shallow linear trend stage 26a. After some additional time period, the monitored feature begins to increase more rapidly, as is best described by the steep linear trend stage 26b of the global automaton 20, which is then added to the local automaton 20′. After the local automaton 20′ is expanded to include this additional stage 26b, the fault prediction process 42 is carried out with each new observation according to the methodology since the steep linear trend stage 26b has an available transition 28 to the faulty stage 24 in the global automaton 20. This results in a predicted fault time, such as the one shown in FIG. 8, where it is compared with the actual fault time of the bearing.

TABLE I shows the MAPE results of the multi-stage model's fault predictions for all seven degradation episodes alongside accuracy results for linear and exponential degradation models proposed in the prior art. The best (lowest) error rate for each test among the three methodologies is shown in bold type in TABLE I.

TABLE I

| | Multi- | Bayesian | Bayesian |
|---|---|---|---|
| Test | Stage | Linear | Exponential |
| No. | Model | Model | Model |
| 1 | 14% | 22% | 49% |
| 2 | 37% | 38% | 48% |
| 3 | 22% | 33% | 49% |
| 4 | 24% | 6% | 50% |
| 5 | 55% | 44% | 44% |
| 6 | 36% | 43% | 48% |
| 7 | 64% | 36% | 49% |

The Bayesian linear and exponential models assume that degradation follows a fixed trajectory with random parameters (a slope parameter for the linear model, and multiplier and time constant parameters for the exponential model). The prior distributions of those parameters must be defined based on historical data, and a Bayesian update method generates posterior distributions when new observations are made. For each test, prior distributions are defined using the other six tests for purposes of the Bayesian models, an approach known as k-fold cross validation. Because those single-stage models do not account for static and shallow linear trend behavior, only data collected after the multi-stage model's first fault prediction are used for purposes of the Bayesian models.

TABLE I shows that the above-described multi-stage model generates the most accurate predictions in four of the seven tests, indicating that the proposed framework and fault prediction methodology can deliver comparable prediction accuracies to traditional single-stage methods, along with implementation advantages for industrial applications. Specifically, the Bayesian degradation models depend on multiple historical degradation episodes (six are used here) to define the prior distributions of their parameters, while the multi-stage model uses only healthy data from the current degradation episode to define its setpoint and noise variance parameters. While historical information on system faults may be available for relatively simple mechanical systems such as roller bearings, the same may not be true for larger and more complex systems. Additionally, the Bayesian models rely on an assumption that the time at which a system starts degrading is definitively known. In contrast, the multi-stage model explicitly considers static and early degradation behavior with the healthy and shallow linear trend stages and detects transitions between these stages in real time. These characteristics make the proposed framework especially well-suited for modeling the health of industrial equipment, particularly equipment for which historical degradation and/or system fault data is unavailable.

In the above examples, the health stages of the local automata are always a subset of the pre-determined global automaton. However, lack of sensors for particular system features, lack of historical data or knowledge regarding relationships between system features and failure events, and/or the long trajectory of some degradation phenomena may result in a given machine or system exhibiting a degradation stage or stage transition that was not known, not observed, and/or not characterized when the global automaton was created. For example, a new and previously unidentified trajectory class associated with an existing signal feature may appear during on-line system monitoring, or the monitored system may be equipped with one or more new sensors able to collect different signal features that were unavailable when the original global automaton was constructed. In some cases, an SME can provide new information about a possible new health stage as well as information on characterizing that health stage, such as what sensors, features, values, and trajectories might be associated with that health stage.

Embodiments of the fault prediction framework may thus include modification of the global automaton 20 such that the local automata 20′ derived therefrom have access to one or more newly uncovered health stages to more accurately update the associated degradation path. An illustrative methodology 30′ is depicted in FIG. 9 that includes the processes of the methodology 30 of FIG. 5 along with the additional step of global automaton expansion 46′. Each new health stage can be characterized in terms of a previously unknown trajectory class, the boundaries of the new stage, and possible transitions to and from health stages that were already part of the global automaton. As more data becomes available, the characterizations of existing stages, boundaries, and transitions in the existing global automaton can be adjusted to better describe current system health and better predict a future system fault. These tasks can be automated, performed by an SME, or partially automated with the SME providing a portion of the definition of each new health stage.

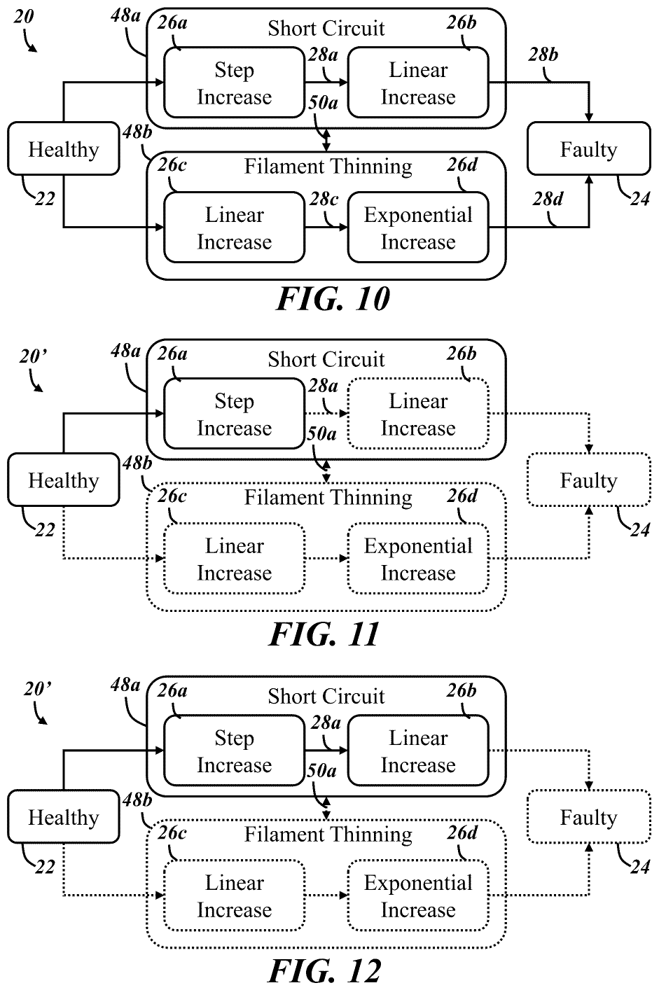

FIG. 10 is an example of a global automaton 20 for use in fault prediction for an industrial filament-based lamp. It should be noted that the degradation paths and signal features used in this example are only hypothetical and used to illustrate an embodiment in which the global automaton 20 is modified during device or system monitoring. The global automaton 20 is based on two known failure modes for the particular type of lamp and lamp application, previously collected feature data, and previously uncovered trends in the feature data leading toward each type of fault. In this case, the two known failure modes are a filament short circuit and excessive filament thinning (e.g., to the point of an open circuit). The objective is to predict when one of these failure modes is imminent and would trigger a fault event 24 so that the lamp can be replaced before failure but not so early as to waste additional useful service life. As noted above, wasted service life is a problem with preventative maintenance schedules that include servicing an industrial system based on the low end of average component service life.

In the illustrated global automaton 20, each potential failure mode has an associated degradation path 48a, 48b including an irreversible progression through two respective degradation health stages 26a. 26b and 26c, 26d. The short circuit degradation path 48a includes a health stage 26a characterized by a step increase trajectory class for a signal feature (e.g., temperature or lumens), followed by a transition 28a to a health stage 26b characterized by a linearly increasing trajectory class for the same signal feature, and, finally, a transition 28b to the faulty stage 24. The filament-thinning degradation path 48b includes a health stage 26c characterized by a linearly increasing trajectory class for a signal feature (e.g., temperature or lumens), followed by a transition 28c to a health stage 26d characterized by an exponentially increasing trajectory class for the same signal feature, and, finally, a transition 28d to the faulty stage 24. The illustrated global automaton 20 also includes a reversible transition 50a between the two degradation paths 48a. 48b indicating that the degradation path may change during monitoring. The dominant degradation path is the degradation path along which the fault prediction time is soonest among multiple degradation paths and includes the current health stage.

FIG. 11 illustrates an example of a local automaton 20′ based on the global automaton 20 of FIG. 10. Here, the monitored device has transitioned from the healthy stage 22 to the first health stage 26a along the short circuit degradation path 48a—that is, a step increase in the monitored signal feature has been observed, but no linear increase in that signal feature has yet been detected. The short circuit degradation path 48a is now the active or dominant degradation path.

From here, assuming the same signal feature (e.g., lumens) used to define health stages 26a, 26b is also used to define the health stages 26c, 26d along the filament thinning degradation path 48b, the next expected transition along the short circuit degradation path 48a is to a linearly increasing trend in that signal feature via the transition 28a from health stage 26a to 26b, although the health stages 26c, 26d of the filament thinning degradation path 48b are considered during the stage estimation process 38 of FIG. 9 while the system is in health stage 26a due to the presence of the transition 50a between degradation paths. In this univariate example, the monitored system can be in only a single health stage at any given time. Which of the health stages 26b-26d is transitioned to from the step increase health stage 26a may depend on the parameters and/or boundaries of the state equation for each health stage and/or the probability matrix associated with respective transitions 28a, 50a. The probability matrix associated with transition 50a may reflect the historical likelihood of each failure mode, for example, to bias the methodology toward the more likely degradation path 48a, 48b. If a linear increase in the signal feature is detected, which of the health stages 26b, 26c is transitioned to will depend on the parameters and/or boundaries of the respective state equation.

In the example of FIG. 12, the monitored device has transitioned to health stage 26b along the short circuit degradation path 48a, and the fault prediction process 42 of the methodology 30 of FIG. 9 may begin estimating a time to reach the faulty stage 24 since health stage 26b along the short circuit degradation path 48a has a transition 28b to the faulty stage 24. Simultaneously, the stage estimation process 38 may continue to consider transitions to health stage 26c or 26d along the filament thinning degradation path 48b via transition 50a—for example if the trajectory of the linear increase changes to be more in line with the state equation parameters and/or boundaries of that health stage 26c, or if the trajectory of the signal feature begins to increase exponentially. However, the linear increase health stage 26c along the filament thinning degradation path has no transition to the faulty stage 24 in the global automaton 20 of FIG. 10, and fault predictions would cease in the case of a transition to health stage 26c. In FIG. 12, the monitored device is in the final degradation stage 26b of the short circuit degradation path 48a, which is currently the dominant degradation path.

From here, should an exponential increase be detected in the monitored signal feature, the monitored device will transition to health stage 26d of the filament thinning degradation path 48b such that the fault prediction process 42 (FIG. 9) may begin to estimate a time to reach the faulty stage 24 based on the newly detected exponential trend toward a filament thinning fault. In that case, the local automaton 20′ may expand via transition 50a to the filament thinning degradation path 48b as the dominant degradation path.

During monitoring according to the global automaton 20 of FIG. 10, it is possible that an unexpected trend in a monitored signal feature will emerge, and, in some cases, an unexpected degradation path may emerge related to that signal feature. In some embodiments of the fault prediction system and adaptive methodology, the global automaton may be modified in response to detection of an unexpected trend, such as a detected anomaly that does not fit within the original global automaton.

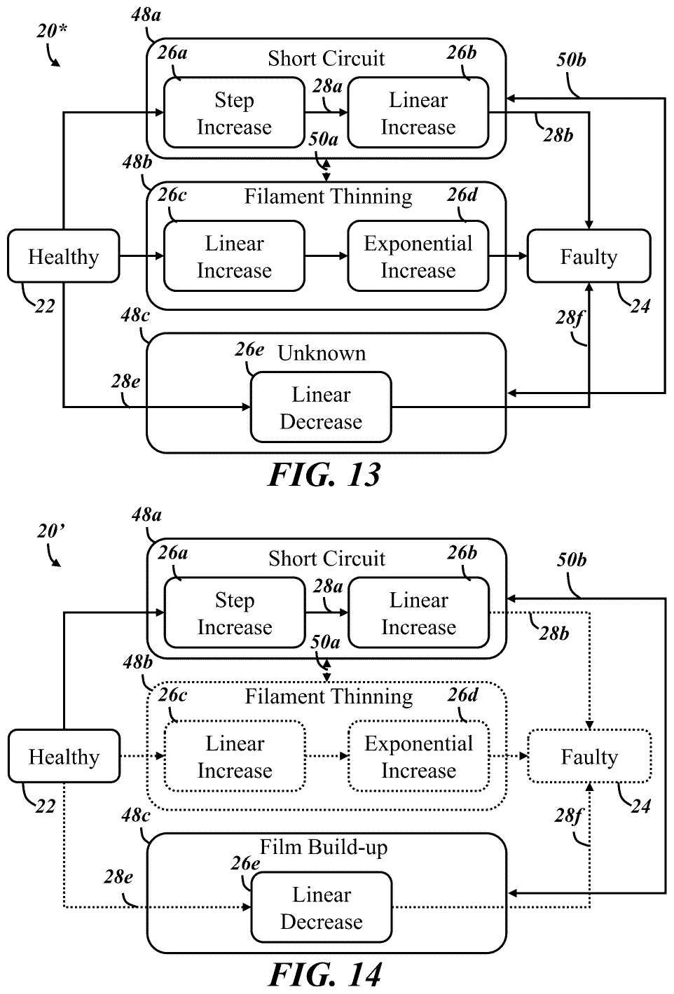

FIG. 13 illustrates an updated global automaton 20* based on the global automaton 20 of FIG. 10 after a linear decreasing trend in the monitored signal feature is detected. As noted above, the monitored signal feature for the two identified degradation paths 48a, 48b may be lumens in the industrial lamp example. But there is no health stage in the original global automaton 20 in which there is a decreasing trend for that signal feature. In response, the original global automaton 20 is updated to include the newly detected trajectory class for the monitored signal feature as part of a new health stage 26e in the updated global automaton 20*.

Upon detection of the new feature trend in the monitored signal feature, it may not yet be known whether the detected trend is representative of an unexpected degradation path separate and distinct from the short circuit and filament thinning degradation paths 48a, 48b, or a newly discovered trend that lies along one of the already identified degradation paths. In this case, the default assumption is a new degradation path 48c with respective transitions 28e, 28f from the healthy stage 22 and to the faulty stage 24. The fault prediction system may prompt the user to identify parameters for the new health stage 26e including, for example, a label for the trajectory class, a state equation, fixed and variable parameters of the state equation, and parameter constraints, as in the examples of FIGS. 1 and 2. Or the system may use default parameters, such as (in the present hypothetical) the same parameters as one of the existing linear increasing health stages 26b, 26c but with a negative slope constraint, after which an SME or other user can update the default parameters based on their experience, investigation, and/or off-line analysis of the new signal feature trend as more data is collected.

In other words, while the fault prediction system may be configured to recognize a previously unidentified signal feature trend and prompt a change in the global automaton 20, human intervention can accelerate identification of the meaning and usefulness of the newly detected trend to more accurately update the global automaton. It may be apparent to an SME, for example, that the newly identified feature trend should be made part of one of the pre-existing degradation paths 48a, 48b instead of a distinct degradation path 48c as in the illustrated example. Or an SME may determine that the acceptable variation or noise in the monitored signal feature should be increased rather than adding the new health stage 26e of new degradation path 48c.

In the present hypothetical, physical inspection of the monitored industrial lamp may reveal a film build-up on the inner surface of the glass encasing the lamp filament and that the film build-up is causing the monitored lumens signal to decrease. From this, the existence of the new degradation path 48c may be verified for which the faulty stage 24 is recognized as a lamp emitting insufficient light for its designated purpose. The user can thus verify the default assumption of a new degradation path 48c and the transition 28f from the new health stage 26e to the faulty stage 24. In other examples, the default assumption is a transition to the new feature trend along the same degradation path from the health stage of the system during which the new trend was detected.

Inclusion of the new health stage 26e and/or degradation path 48c may also necessitate updates to the description, parameters, and constraints for the trajectory classes of the original or previous global automaton 20 and/or updates to the various transitions 28 of the original global automaton. For instance, it may be discovered that one of the linearly increasing health stages has distinct linear trends with different slopes such that additional constraints on the slope of the state equation are necessary to delineate between the two different feature trajectories. Updates to parameters of the various steps 38-44 of the routine system monitoring 36 (FIG. 9) may also be required and implemented by an SME. In the illustrated example, due to the timing of the observance of the new feature trend, a transition 50b between the short circuit degradation path 48a and the new degradation path 48c is included in recognition that the faulty stage 24 may be reached by either degradation path and that the health stage and degradation path may change as more data is collected.

Once the characteristics of the trajectory class of the new health stage 26e, along with transitions to and from the new health stage 26e, are verified or determined and updated in the updated global automaton 20*, some characteristics of the adaptive methodology 30 described in conjunction with FIG. 9 may also be modified to accommodate the new global automaton 20*. For instance, parameters of some of the repetitive processes 38-44 are updated to accommodate the added health stage 26e and transitions to and from the new health stage. In the stage estimation process 38, for example, the transition probability matrix used in the prediction step is updated to reflect possible transitions to and from the newly added health stage. Other updates may be required and made automatically, by an SME, or with default parameters established automatically and finalized by the SME or other user. For example, as more signal feature data is obtained during the linear decrease health stage 26e, the parameters of the respective state equation may be learned and/or refined, potentially with targeted analysis of the sensor data based on the new-found knowledge.

The local automaton 20′ of FIG. 12 may then expand according to the updated global automaton 20* as in FIG. 14, for example, where the “unknown” degradation path 48c has been identified in the updated global automaton as a “film build-up” degradation path. Here, the stage history for the monitored device includes a step increase 26a in the monitored feature, a linear increase 26b in the monitored feature, and a linear decrease 26e in the monitored signal feature. Fault predictions are ongoing along the film build-up degradation path 48c because that degradation path is in its final health stage 26e according to the latest global automaton. No fault predictions are on-going for the short circuit degradation path 48a or the filament thinning degradation path 48b because the current health stage is along neither of those paths.

As system monitoring continues, the local automaton 20′ may change from that of FIG. 14 to one in which one of the other degradation paths 48a, 48b becomes dominant. For example, an exponential increase may be detected in the monitored signal feature indicating that the monitored system has progressed to health stage 26d of the filament thinning path 48b. This would make the filament thinning degradation path 48b dominant. The global automaton may again be modified in that case to include a transition 28 between the film build-up degradation path 48c and the filament thinning degradation path 48b.

In some embodiments, the fault prediction methodology includes automatic addition of a transition between the health stage of a newly detected signal trend and the current health stage during which the new signal trend was detected. In some embodiments, such as when a new failure mode occurs in conjunction with a newly identified feature trend, a transition is automatically added from the health stage of the newly detected signal trend to the faulty stage 24. The updated global automaton 20* can then be implemented after the system fault is addressed so that the methodology can continuously consider the new health stage and associated fault.

In the case of an industrial facility using and monitoring a plurality of the same type of device (e.g., multiple industrial lamps of the same model), the global automaton 20 can be updated to include a health stage with the new feature trend and/or new degradation path for application to all other remaining instances of the monitored device in the facility. In such cases, information may be pooled across the multiple devices or systems being monitored to further refine the global automaton as the body of information grows. In this manner, fault prediction for machines or systems that have yet to exit the healthy stage 22 or have yet to enter a degradation health stage adjacent the faulty stage 24 can be immediately refined based on feature trends and degradation paths uncovered during the life of similar systems.

In some embodiments, the global automaton is modified based at least in part on addition of a new sensor or measuring system by which the monitored system is monitored. In the above industrial lamp example, an SME or other user may identify a more appropriate metric for the film build-up degradation path 48c and modify the global automaton to replace the lumens signal feature with a new signal feature (e.g., glass transparency) that is more indicative of or more sensitive to the film build-up degradation path 48c. The addition of new health stages to the global automaton during system monitoring is not limited to newly discovered feature trends or system faults. For example, an SME may have an idea or have knowledge that adding a particular sensor to the monitored system to track an additional signal trend will improve fault prediction and/or be more cost effective. That sensor can be added to collect the corresponding signal feature, and the existing global automaton can be updated to include one or more new trajectory classes associated with the signal feature, along with expected transitions to and from the associated health stages. In some cases, this allows system monitoring to begin without delay—i.e., before the optimum sensor suite is installed—and, in other cases, allows updates to the existing global automaton without waiting for a fault to happen or be predicted for an industrial system already being monitored.

In some systems, degradation paths may occur in parallel. This phenomenon can be determined by a combination of data analysis and SME input. Embodiments of the above-described fault prediction framework can support expansion of the global automaton to allow for and detect degradation paths occurring in parallel, such as degradation paths based on one or more different signal features. The health stage and transition process described can be expanded to identify parallel-occurring degradation paths and failure modes and predict faults associated with each failure mode.

Embodiments of the methodology are applicable to industrial processes. Generally, the method involves monitoring any signal feature and assigning it to a current health stage based on the estimated feature trend selected from feature trends identified in the global automaton. As a simple example embodied in the global automaton 20 of FIG. 3, the monitored signal feature may be a characteristic of a product produced by an industrial process, such as a dimension or weight of the product. The healthy stage 22 may be defined as an in-spec dimension when a tool making the product is new, with the faulty stage 24 defined as a dimension at or above a threshold value. Based on an SME's experience with such tools, the global automaton of FIG. 3 indicates that there are times when the monitored dimension increases linearly for the life of the tool, and there are times when the monitored dimension increases exponentially for the life of the tool. There are also times with the monitored dimension begins to increase exponentially after increasing linearly for some time. The methodology identifies the current health stage of the process so a more accurate predication can be made as to when the process will begin producing a product with an out-of-spec dimension. This provides benefits over other process maintenance methods, some of which would assume the worst case scenario of an exponential increase in the product dimension for the life of the tool, thus always avoiding a fault (out-of-spec product dimension), but sometimes not obtaining actual full tool life. Other methods such as statistical process control (SPC) would not always identify an impending fault so long as dimensional variation is under control.

In another simple example embodied in the global automaton 20 of FIG. 3, the monitored signal feature may be a scrap rate associated with a particular process. Based on an SME's experience with the process, the global automaton of FIG. 3 indicates that there are times when the scrap rate increases linearly toward an unacceptable threshold, and there are times when the scrap rate increases exponentially toward that threshold. There are also times with the scrap rate begins to increase exponentially after increasing linearly for some time. Each category of scrap rate increase may be associated with different factors. For example, it may be that exponential increases in scrap rate are usually due to a different problem than linear increases in scrap rate (e.g., a change in material supplier versus a change in the seasons). Knowing which health stage the process is currently experiencing can thus help identify a root cause.

Embodiments of the above-described fault prediction framework and methodology may be at least partially computer-implemented. The repetitive tasks and processes involved in the continuous system monitoring 36 described in conjunction with FIGS. 5 and 9 are particularly suited to computer-implementation with adjustable parameters selected by an SME or other user. A computer implemented portion of embodiments of a fault prediction system includes at least one processor and memory-implemented as one or more non-transitory computer-readable mediums-storing or having instructions that, when executed by the at least one processor, cause the system to perform any combination of one or more of the above-described method steps and/or one or more method steps based on or derivable from the above-discussed fault prediction framework and methodology.

It is to be understood that the foregoing description is of one or more preferred example embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method for predicting a system fault in a monitored system based on a predefined global automaton that includes a plurality of distinct degradation stages, a transition from a healthy stage to at least one of the degradation stages, and a transition from at least one of the degradation stages to a faulty stage,
wherein each of the plurality of degradation stages corresponds to a different signal feature trajectory class.

2. The method of claim 1, wherein each trajectory class is defined at least in part by a monitorable signal feature of the system and a state equation that is a function of the signal feature, the state equation being different for each of the feature trajectory classes.

3. The method of claim 1, wherein each trajectory class is defined at least in part by a monitorable signal feature of the system and a state equation that is a function of the signal feature and a variable parameter, the variable parameter being different for each of the feature trajectory classes.

4. The method of claim 1, wherein each trajectory class is defined at least in part by a monitorable signal feature, a state equation that is a function of the signal feature and a parameter, and a constraint on the parameter.

5. The method of claim 1, wherein each trajectory class corresponding to one of the degradation stages having a transition to the faulty stage is a trending trajectory class.

6. The method of claim 1, wherein the global automaton includes a plurality of degradation paths from the healthy stage to the faulty stage.

7. The method of claim 6, wherein at least one of the plurality of degradation paths includes more than one of the plurality of degradation stages.

8. The method of claim 1, further comprising an iterative fault prediction step based on extrapolation of a signal feature trajectory of one of the degradations stages having a transition to the faulty stage.

9. The method of claim 1, further comprising an iterative fault prediction step based on a signal feature history and health stage history of the monitored system and independent from external degradation models.

10. The method of claim 1, wherein one of the plurality of degradation stages is an unknown degradation stage used to capture signal feature behavior that does not fit within any of the other degradation stages.

11. The method of claim 1, further comprising repeated system monitoring, including:
observing a new instance of a signal feature upon which each trajectory class is based; and
making a determination pertinent to a current health stage of the monitored system using the observed new instance of the signal feature, wherein the current health stage is selected from the healthy stage or one of the degradation stages of the global automaton.

12. The method of claim 11, wherein the step of making the determination includes using a stage estimation process that determines an estimated probability that the monitored system has transitioned from the current health stage to a next health stage of the global automaton based in part on the observed new instance of the signal feature.

13. The method of claim 11, wherein the step of making the determination includes using a trajectory updating process that determines a value for a variable parameter of a state equation of the trajectory class corresponding to the current health stage based in part on the observed new instance of the signal feature.

14. The method of claim 11, wherein the step of making the determination includes using a fault prediction process that determines a predicted time to reach the system fault by extrapolating a trajectory of the signal feature based on previously observed instances of the signal feature, including the observed new instance of the signal feature.

15. The method of claim 11, wherein the step of making the determination includes using an anomaly detection process that determines whether the observed new instance of the signal feature is anomalous relative to previously observed instances of the signal feature.

16. The method of claim 1, further comprising defining a local automaton indicative of a health stage history of the monitored system, the local automaton including a current health stage of the monitored system selected from the healthy stage or one of the degradation stages, wherein the health stage history includes only health stages that are part of the global automaton.

17. The method of claim 16, further comprising expanding the local automaton to include an additional degradation stage of the global automaton.

18. The method of claim 1, further comprising modifying the global automaton to include a new degradation stage that corresponds to a new signal feature trajectory class.

19. The method of claim 18, wherein the new signal feature class is based at least in part on one or more anomalous signal feature observations.

20. The method of claim 1, wherein the monitored system is an industrial process.
